(19) United States
(12) Patent Application Publication
(10) Pub. No.: US 2026/0238076 A1
(43) Pub. Date: Aug. 13, 2026

(54) COMPRESSOR WITH CONTROLLED MAGNETIC INTERACTION BETWEEN PERMANENT MAGNET ROTOR AND MAGNETIC COMPRESSOR COMPONENTS

(71) Applicant: Copeland LP, Sidney, OH (US)

(72) Inventors: Patrick Shawn O'Meara, Tipp City, OH (US); Michael M. Perevozchikov, Tipp City, OH (US)

(21) Appl. No.: 19/289,884

(22) Filed: Aug. 4, 2025

Related U.S. Application Data
(60) Provisional application No. 63/756,085, filed on Feb. 8, 2025.

(51) Int. Cl. H02K 7/00; H02K 1/2706; H02K 15/40

(52) U.S. Cl. CPC H02K 7/003; H02K 1/2706; H02K 15/40; H02K 2213/03

(57) ABSTRACT

A compressor includes a stator positioned in the compressor housing. The compressor also includes a rotor assembly rotatably supported in the compressor housing comprising a permanent magnet rotor positioned within the rotor assembly. The compressor component also includes a magnetic compressor component positioned a distance from the permanent magnet rotor, wherein the distance is sized to reduce heat generated by the permanent magnet rotor.

### CROSS REFERENCE TO RELATED APPLICATION

This application claims priority to U.S. Provisional Patent Application No. 63/756,085, filed Feb. 8, 2025, the entire disclosure of which is incorporated by reference.

### FIELD

The field of the disclosure relates generally to compressors and, more particularly, to compressors that include one or more bearing structures and a permanent magnet rotor.

### BACKGROUND

Centrifugal compressors have advantages over positive displacement compressor designs, such as reciprocating, rotary, and screw compressors. A centrifugal compressor typically operates with a relatively high rotational speed of the driveshaft and impeller. This high speed presents challenges for providing a suitable operating environment for the driveshaft, impeller, and associated motor.

Centrifugal compressors typically include bearings to support the shaft when rotating at high speeds. Some bearings use oil or alternative compositions as a lubricant. The lubricant compositions may be incompatible with the working fluid (e.g., refrigerant) used with the compressor. Other bearings are oil-free magnetic bearings that levitate the shaft within a magnetic field provided by high-strength magnets. However, magnetic bearings are typically complex in design, add significant weight, require complicated control, and limit the choice of rotor materials to ferromagnetic materials that respond to the magnetic fields within the magnetic bearings.

This background section is intended to introduce the reader to various aspects of art that may be related to various aspects of the disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

### SUMMARY

In one aspect a compressor includes a compressor housing. A stator is positioned in the compressor housing. The compressor also includes a rotor assembly rotatably supported in the compressor housing. The rotor assembly includes a permanent magnet rotor positioned within the rotor assembly. The compressor also includes a magnetic compressor component positioned a distance from the permanent magnet rotor. The distance is sized to reduce heat generated by the permanent magnet rotor.

In another aspect a refrigeration system includes an evaporator operable to evaporate a working fluid. The refrigeration system includes a condenser to condense the working fluid. The refrigeration system also includes a compressor connected to each of the evaporator and the condenser. The compressor is operable to compress the evaporated working fluid downstream from the evaporator and upstream from the condenser. The compressor includes a compressor housing, a stator in the compressor housing, and a rotor rotatably supported in the compressor housing. The rotor includes a shaft extending between first and second axial shaft ends. The shaft includes a hollow and a permanent magnet rotor positioned within the hollow of the shaft. The compressor also includes a magnetic compressor component positioned a distance from the permanent magnet rotor. The distance is sized to reduce heat generated by the permanent magnet rotor.

In yet another aspect a method of assembling a compressor includes positioning a rotor in a housing of the compressor. The rotor includes a shaft extending between first and second axial shaft ends and a permanent magnet rotor positioned within the shaft. The permanent magnet rotor extends between first and second axial magnet ends. The method also includes positioning a stator in the housing and determining, based on the magnetic flux, a distance between the first and second axial magnet ends and a magnetic component of the compressor. In the method the distance corresponds to reduced heat generation between the permanent magnet rotor and the magnetic component of the compressor. The method also includes positioning the magnetic component within the compressor at the distance from the permanent magnet rotor.

Various refinements exist of the features noted in relation to the above-mentioned aspects of the present disclosure. Further features may also be incorporated in the above-mentioned aspects of the present disclosure as well. These refinements and additional features may exist individually or in any combination. For instance, various features discussed below in relation to any of the illustrated embodiments of the present disclosure may be incorporated into any of the above-described aspects of the present disclosure, alone or in any combination.

### BRIEF DESCRIPTION OF THE DRAWINGS

The following figures illustrate various aspects of the disclosure;

FIG. 1 is a perspective view of an assembled compressor;

FIG. 2 is a cross-sectional view of the compressor of FIG. 1 taken along line 2-2, with the external conduit removed;

FIG. 3 is a cross-sectional view of the compressor of FIG. 2 with the external compressor housing removed; and

FIG. 4 is a schematic of an example refrigeration system suitable for use with the compressor shown in FIG. 1.

Corresponding reference characters indicate corresponding parts throughout the drawings.

### DETAILED DESCRIPTION

This disclosure relates to compressors that includes a shaft that rotates with one or more impellers to impart kinetic energy to incoming working fluid (e.g., refrigerant). Rotation of the shaft is caused by interaction between magnetic fields induced in a stator coil and a magnetic field of a permanent magnet rotor that is connected to and rotates with the shaft. In the examples described, the permanent magnet rotor is positioned within the shaft. The location of the permanent magnet rotor creates the risk of heat generation due to a magnetic interaction between magnetic (e.g., ferrous) material of the compressor and the rotor. For example, the magnetic material may include one or more magnetic compressor components such as a portion of the shaft, the bearing system to support the shaft, a housing to support the bearing system, a bearing sleeve, and other ferrous materials of the compressor. The magnetic interaction between the permanent magnet rotor and the magnetic material of the compressor must be limited or prevented to avoid heat generation from the shaft. Accordingly, in the examples described, the magnetic material of the compressor is located a suitable distance from the permanent magnet rotor to control the magnetic interaction between these components, prevent or limit heat generated by the permanent magnet rotor, and improve the operation lifetime and effectiveness of the compressor. For example, maintaining the distance from the permanent magnet rotor decreases the operating temperature within the compressor 10°-25° F.

For conciseness, examples will be described with respect to a two-stage centrifugal compressor operable to compressor a working fluid (e.g., refrigerant). However, the aspects of the present disclosure may be applied to other suitable compressors, including single-stage centrifugal compressors, and other turbomachines, such as turbine engines, turbochargers, and the like.

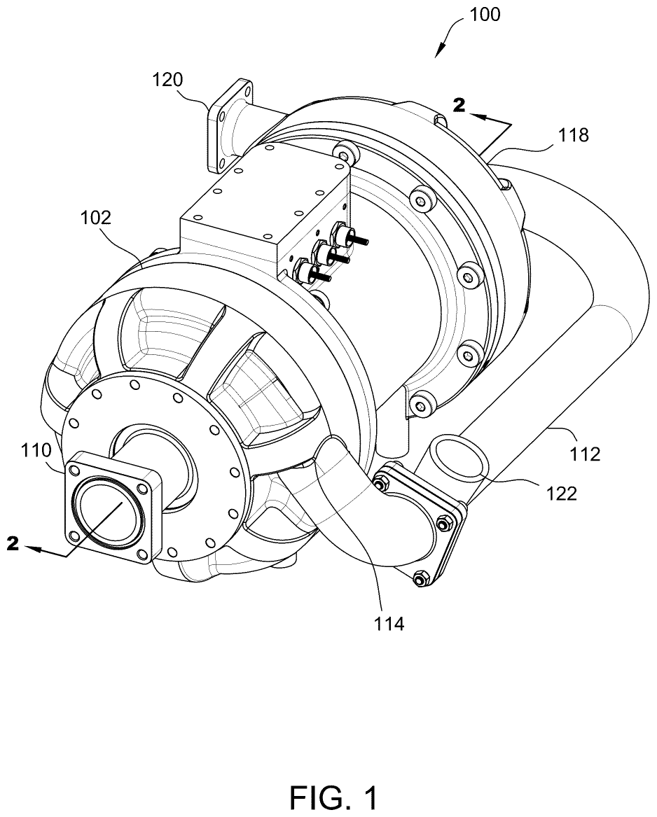

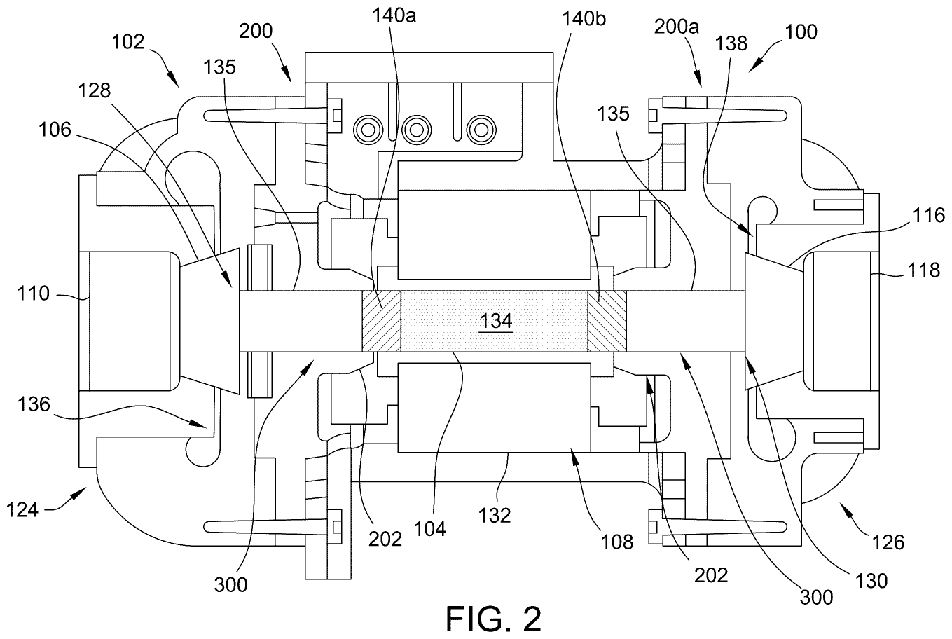

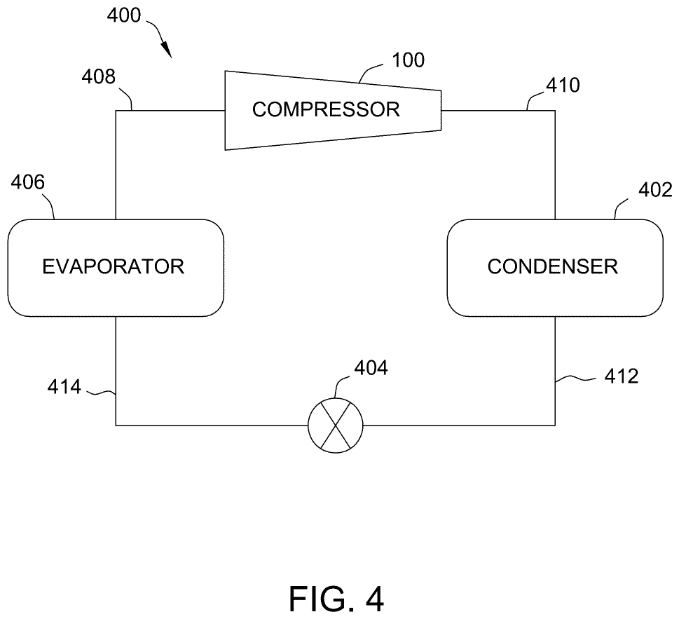

Referring to FIG. 1, a turbomachine illustrated in the form of a two-stage refrigerant compressor is indicated at 100. The compressor 100 includes a compressor housing 102 forming at least one sealed cavity within which each stage of refrigerant compression is accomplished. The compressor 100 includes a first refrigerant inlet 110 to introduce refrigerant vapor into a first compression stage 124 (see FIG. 2), a first refrigerant exit 114, a refrigerant transfer conduit 112 to transfer compressed refrigerant from the first compression stage to the second compression stage, a second refrigerant inlet 118 to introduce refrigerant vapor into a second compression stage 126 (see FIG. 2), and a second refrigerant exit 120. The refrigerant transfer conduit 112 is operatively connected at opposite ends to the first refrigerant exit 114 and the second refrigerant inlet 118, respectively. The second refrigerant exit 120 delivers compressed refrigerant from the second compression stage to a cooling system (e.g., a refrigeration system 500 shown in FIG. 4) in which compressor 100 is incorporated. The refrigerant transfer conduit 112 may further include a refrigerant port 122 for introducing an auxiliary stream of refrigerant into the conduit 112, such as from an economizer for example.

Referring to FIG. 2, the compressor housing 102 encloses the first compression stage 124 and the second compression stage 126 at opposite ends of the compressor 100. The first compression stage 124 includes a first stage impeller 106 operable to impart kinetic energy to working fluid (e.g., refrigerant) entering via the first refrigerant inlet 110. The working fluid is also referred to as refrigerant with reference to the compressor 100. In other examples, and more particularly in other types of turbomachines, the working fluid may include another type of working fluid (e.g., air) depending on the type of turbomachine. The kinetic energy imparted to the refrigerant by the first stage impeller 106 is converted to increased refrigerant pressure (i.e., compression) as the refrigerant velocity is slowed upon transfer to a diffuser 136. Similarly, the second compression stage 126 includes a second stage impeller 116 operable to impart kinetic energy to refrigerant transferred from the first compression stage 124 entering via the second refrigerant inlet 118. The kinetic energy imparted to the refrigerant by the second stage impeller 116 is converted to increased refrigerant pressure (i.e., compression) as the refrigerant velocity is slowed upon transfer to a diffuser 138. Compressed refrigerant exits the second compression stage 126 via the second refrigerant exit 120 (shown in FIG. 1).

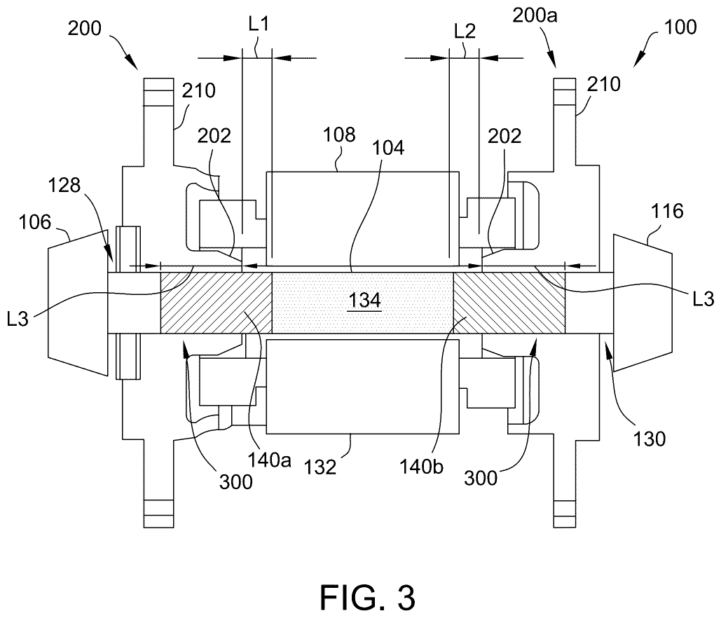

Referring to FIG. 2 and FIG. 3, the first stage impeller 106 and second stage impeller 116 are connected at opposite ends 128, 130 of a shaft 104 supported within the compressor housing 102. The shaft 104, the first stage impeller 106, and the second stage impeller 116 may be connected to rotate in unison as a rotor assembly. The shaft 104 is operatively connected to a motor assembly 108, or motor 108, positioned between the first stage impeller 106 and second stage impeller 116 such that the first stage impeller 106 and second stage impeller 116 are rotated at a rotation speed selected to compress the refrigerant to a pre-selected pressure exiting the second refrigerant exit 120. Any suitable motor 108 may be incorporated into the compressor 100 including, but not limited to, an electrical motor.

The motor assembly 108 includes a stator 132 and a permanent magnet rotor 134. The stator 132 is annular in shape and surrounds the shaft 104 and permanent magnet rotor 134. The stator 132 includes at least one electromagnetic coil winding (not shown). In some examples, the motor assembly 108 is a three-phase induction motor and the stator 132 has three sets of stator windings. Each winding includes an electrically conductive wire (e.g., copper) wound around a tooth portion (not shown) for a number of turns. The stator 132 may also include insulation (not shown) surrounding the windings.

In the example compressor 100, the permanent magnet rotor 134 is positioned within the shaft 104. The permanent magnet rotor 134 includes any suitable permanent magnet material, such as a neodymium-iron-boron (Nd—Fe—B) alloy. The permanent magnet rotor 134 is cylindrically shaped in this example. The shaft 104 includes a hollow portion between the two shaft ends 128, 130 in which the permanent magnet rotor 134 is positioned. The rotor assembly includes one or more magnetic zones 135 positioned within the hollow portion of the shaft 104. The one or more magnetic zones 135 are positioned a distance, such as an axial distance, from the permanent magnet rotor 134 to reduce heat generated by the magnetic interaction of the permanent magnet and other magnetic material in the rotor assembly. The hollow portion of the shaft 104, the permanent magnet rotor 134, and the magnetic zone 135 enclose an air gap. The air gap may be formed by the hollow portion of the shaft 104 along the distance between the permanent magnet rotor 134 and the magnetic zone 135.

The permanent magnet rotor 134 is fixed within the shaft 104 using any suitable means (e.g., press fit, adhesive, mechanical connections, and the like). The permanent magnet rotor 134 is also referred to as a permanent magnet 134 or magnet 134. The shaft 104 may include a shaft sleeve that receives the permanent magnet rotor 134 and the one or more magnetic zones 135. The sleeve has a cylindrical shape corresponding to the cylindrical shape of the permanent magnet rotor 134. The shaft sleeve of the shaft 104 suitably includes a metal alloy, such as a nickel-chromium alloy (e.g., Inconel® material).

The shaft 104 includes one or more magnetic zones 135 positioned within the hollow portion of the shaft 104 and extending towards the impeller 106, 116. The magnetic zone 135 may include a necked down portion extending into the impeller 106,116. Each magnetic zone 135 is secured within the axial ends of the hollow portion of the shaft 104 with a mechanical connection, such as a press fit connection between the hollow portion of the shaft 104 and the magnetic zone 135. For example, a first magnetic zone 135 extends from first axial end of the hollow portion of the shaft 104 to the first nonmagnetic zone 140a (discussed later) towards the axial end of the permanent magnet rotor 134. The second magnetic zone 135 extends from second hollow portion of the shaft to the second non-magnetic zone 140b (discussed later) towards the axial end of the permanent magnet rotor 134. The magnetic zone 135 includes the portion of the shaft 104. The magnetic zone 135 may also include the impeller.

In the example embodiment, the shaft includes a non-magnetic zone 140a, 140b. The non-magnetic zone 140a and 140b reduces magnetic interaction that generates heat during operation of the compressor 100. For example, the non-magnetic zone reduces magnetic interaction between the permanent magnet 134 and one or more magnetic compressor components. The non-magnetic zone is less magnetically permeable, such that the magnetic fields of the permanent magnet 134 are less likely to pass through compressor components. The non-magnetic material of the non-magnetic zone 140a and 140b thereby reduces heat generation and ensures that the magnetic fields of the permanent magnet rotor 134 are primarily directed toward the stator 132 without magnetizing the compressor components. The non-magnetic zone 140a and 140b is spaced a distance (such as axial distance L₁ and/or L₂) from the permanent magnet rotor 134 on the shaft 104 to decrease magnetic interaction that generates heat during operation of the compressor 100. L₁ and L₂ may be determined based on the magnetic properties of the compressor 100. L₁ and L₂ may define a portion of the axial length of the air gap. The air gap may also include the volume of the recessed cavity of the magnetic zone 135. For example, L₁ and L₂ may be determined by the magnetic interaction between the first permanent magnet rotor 134 and the non-magnetic zone 140a and 140b. The axial distance L₁, L₂ may extend beyond the magnetic field of the permanent magnet rotor 134. The non-magnetic air gap reduces the effects of the magnetic field from the permanent magnet rotor 134 to prevent heat generation during operation of the compressor 100. The air gap is a magnetic insulator between the permanent magnet rotor 134 and the non-magnetic zone 140a and 140b. Reducing the heat generated by the permanent magnet rotor 134 improves the efficiency of the compressor 100 during operation and reduces thermal stress on compressor components.

The first non-magnetic zone 140a extends distally from a first axial end of the permanent magnet rotor 134 and spans at least a portion of the axial length of the shaft 104. The second non-magnetic zone 140b extends distally from a second axial end of the permanent magnet rotor 134 and spans at least a portion of the axial length of the shaft 104. The internal void may extend at least a portion of the length of each non-magnetic zone 140a and 140b.

In operation of the compressor 100, the stator 132 generates a magnetic field via current supplied through the windings. The generated magnetic field interacts with the magnetic field of the permanent magnet rotor 134, causing the permanent magnet rotor 134 to rotate. The permanent magnet rotor 134 is rotatably fixed within the shaft 104, such that rotation of the permanent magnet rotor 134 drives rotation of the shaft 104 and the impellers 106, 116.

The shaft 104 is rotatably supported by bearing system assemblies 300. Examples of bearing assemblies suitable for use in the compressor 100 are described in U.S. patent application Ser. No. 18/617,018, filed Mar. 26, 2024, U.S. patent application Ser. No. 18/162,396, filed Jan. 31, 2023, issued as U.S. Pat. No. 11,852,153 on Dec. 26, 2023, U.S. patent application Ser. No. 17/167,611, filed Feb. 4, 2021, issued as U.S. Pat. No. 11,686,341 on Jun. 27, 2023, U.S. patent application Ser. No. 16/809,836, filed Mar. 5, 2020, issued as U.S. Pat. No. 11,306,726 on Apr. 19, 2022, and U.S. patent application Ser. No. 16/783,369, filed Feb. 6, 2020, issued as U.S. Pat. No. 11,391,291 on Jul. 19, 2022, the disclosures of which are incorporated by reference in their entirety.

In the example compressor 100, each bearing assembly 300 is positioned within a bearing housing 200, 200a, as described in additional detail below. The bearing housings 200, 200a and the bearing assemblies 300 positioned within the bearing housings 200, 200a may be referred to, or included as part of, a bearing system. The bearing assembly may be positioned within a bearing sleeve 202. The bearing sleeve 202 may be positioned within or integral to the bearing housing 200, 200a. The bearing sleeve 202 has a radial surface that defines a cylindrical bore. The radial inner surface of the bearing sleeve 202 is sized and dimensioned to receive the bearing assembly. The bearing sleeve 202 secures the bearing assembly at a fixed rotational position within the bearing housing 200,200a. In the example embodiment, the bearing sleeve includes a radial flange to attach the bearing assembly to the bearing housing. In some embodiments, the bearing sleeve 202 includes a mechanical interlock, such as a slit formed on the radial inner surface of the bearing sleeve 202, to secure the bearing assembly. Each bearing housing 200, 200a includes a mounting structure 210 for connecting the respective bearing housing 200, 200a to the compressor housing 102, as illustrated in FIG. 3. In the example compressor 100, two bearing housings 200, 200a are included, each positioned proximate one of the impeller stages 124, 126. Correspondingly, two bearing assemblies 300 are included, each positioned in one of the bearing housings 200, 200a. The number of bearing assemblies 300 and bearing housings 200, 200a may vary depending on the configuration and intended application of the compressor 100. For example, there may be one bearing housing 200 and one bearing assembly 300, or there may be more than two, such as three, bearing housings 200 and bearing assemblies 300.

Each bearing housing 200, 200a supports the shaft 104. The shaft 104 extends through the bearing housings 200, 200a. The two ends 128, 130 of the shaft 104 each project outward from the bearing housings 200, 200a, opposite the bearing sleeve 202. The impellers 106 and 116 are connected to the projecting ends 128, 130 of the shaft 104. The bearing housings 200, 200a are similar in construction and configuration, and description and illustration of the bearing housing 200 applies equally to the bearing housing 200a unless expressly stated otherwise or the context clearly indicates otherwise.

The material (e.g., metal alloy, such as stainless steel) from which at least a portion of the compressor 100 is constructed may include an amount of iron that imparts magnetic properties. In some examples, the compressor 100 includes ferrous stainless steel. The magnetic properties of the compressor 100 create the risk of magnetic interaction between the magnet 134 and the compressor, resulting in heat generation. The heat is generated by the interaction between the compressor 100 and the magnets 134 on the shaft 104, which can degrade performance of the compressor 100. As described below, in the example compressor 100, the position of the magnet 134 is controlled to limit or prevent magnetic interaction between the compressor 100 and the magnet 134 from generating heat.

The example compressor 100 includes bearing assemblies 300 positioned relative to the shaft 104, with various components omitted for ease of illustration and description. A first bearing assembly 300 is positioned proximate a first end 128 of the shaft and the first stage impeller 106. A second bearing assembly 300 is positioned proximate a second end 130 of the shaft 104 and the second stage impeller 116. The permanent magnet rotor 134 is positioned between the first and second bearing assemblies 300. The permanent magnet rotor 134 may be positioned within the shaft sleeve of the shaft 104 between the first and second bearing assemblies 300. The distance L₁ and L₂ reduce heat generated between the rotor 134 and the bearing assembly 300. Similar reductions in heat generation are similarly applicable to other magnetic components of the compressor 100.

In the example compressor 100 the magnetic components, such as the first bearing assembly 300, is spaced a distance, such as axial distance L₁, from the permanent magnet rotor 134. The second bearing assembly 300 is also spaced a distance, such as axial distance L₂, from the permanent magnet rotor 134. The axial distance L₁ and L₂ provide an example of the minimum distance between the permanent magnet rotor 134 and any magnetic component of the compressor 100 to reduce friction. Due to the location of the permanent magnet rotor 134 within the shaft and ferrous material (e.g., ferrous stainless steel) in the compressor 100, there is a risk that magnetic interaction between the permanent magnet rotor 134 and the compressor 100 will occur which generates eddy currents within the components of compressor 100. The interaction between the permanent magnet rotor 134 and the ferrous material of the compressor 100 generate heat within the compressor components, such as the bearings 300.

In accordance with the present disclosure, the distance between the magnetic component of the compressor 100 and the permanent magnet rotor 134, such as axial distances L₁ and L₂, are each sized to limit, or prevent, magnetic interaction. For example, the axial distances L₁, L₂ can be determined empirically and/or prior to operation of the compressor 100. In some examples, the axial distances L₁, L₂ are approximately equal to one another. In other examples, the axial distances L₁, L₂ are different from one another. In some examples, the axial distance L₁ and/or L₂ is at least 10 millimeters (mm). For example, the axial distances L₁, L₂ are each independently between 10 mm to 30 mm, such as between 10 mm to 20 mm, or between 14 mm to 16 mm.

In some examples, the distance between the magnetic component of the compressor and the permanent magnet rotor 134 are determined as a function of the size, and more particularly the diameter D, of the magnet 134. The size (diameter) of the magnet 134 affects the intensity of the magnetic field of the magnet 134. As such, a greater diameter D of the magnet 134 requires a greater distance to limit or prevent magnetic interaction between the magnet 134 and the bearing assemblies 300. In some examples, the distance for each magnetic component of the compressor, such as axial distances L₁ and L₂, are each independently at least 0.3*D. For example, the distance, such as L₁ and L₂, are each independently between 0.3*D to 0.5*D, such as between 0.3*D to 0.4*D, or between 0.33*D to 0.34*D. In some examples, the distances, such as L₁ and L₂, are each independently between 0.15 mm to 0.35 mm, such as between 0.15 mm to 0.25 mm, or between 0.18 mm to 0.19 mm.

FIG. 4 is a schematic diagram of an example refrigeration system 500 in which the compressor 100 of FIG. 1 is implemented. The refrigeration system 500 includes the compressor 100, a condenser 502, an expansion device 504 (e.g., an expansion valve, orifice, capillary tube), and an evaporator 506. The refrigeration system 500 may include additional components or other components than those shown and described with reference to FIG. 4.

In operation, the compressor 100 receives a working fluid, such as a refrigerant, as a low pressure gas through a suction line 508. The compressor 100 compresses the low pressure refrigerant gas, thereby raising the temperature and pressure of the refrigerant. The compressed, high temperature refrigerant exiting the compressor 100 is channeled towards the condenser 502 via a line 510. The compressed refrigerant passes through the condenser 502, where the refrigerant is condensed to a high pressure liquid or a high pressure liquid-gas mixture. The compressed, condensed refrigerant exiting the condenser 502 via a line 512 is channeled towards and passes through the expansion device 504 that expands the refrigerant, thereby reducing the pressure of the refrigerant. The expanded (or “uncompressed”) refrigerant exiting the expansion device 504 via a line 514 may be a gas or a mixture of gas and liquid after passing through the expansion device 504. The uncompressed refrigerant exiting the expansion device 504 is channeled towards and passes through the evaporator 506. The uncompressed refrigerant fluid evaporates to a gas in the evaporator 506. The uncompressed refrigerant gas exiting the evaporator 506 is channeled back towards the compressor 100 via the suction line 508, where the working fluid is again compressed and the process repeats.

The present disclosure is also related to a method of assembling the compressor 100. Referring to FIGS. 1-4, the compressor 100 is assembled by positioning a rotor that includes the shaft 104 and the permanent magnet 134 in the compressor housing 102 and positioning the stator 132 in the compressor housing 102 such that the stator 132 surrounds the rotor. The method also includes mounting the bearing housings 200, 200a in the compressor housing 102, each bearing housing 200, 200a defining the cylindrical bore 206 in which a respective bearing assembly 300 is positioned. The method also includes connecting the first and second stage impellers 106, 116 to the shaft 104 proximate the respective ends 128, 130 of the shaft 104. The shaft 104 extends through each of the cylindrical bores 206 of the bearing housings 200, 200a and is supported by the bearing assemblies 300.

In accordance with the present disclosure, mounting the bearing housings in the compressor housing 102 includes positioning the bearing assemblies 300 such that the bearing assemblies 300 are each positioned the distance from the permanent magnet 134, such as distances L₁ and L₂, that are sized to limit magnetic interaction between the respective bearing assembly 300 and the magnet 134.

Embodiments of the compressor described enable the use of a rotor that includes a permanent magnet positioned within a rotatable shaft while reducing or eliminating the risk of heat generated by the magnetic interaction of the rotor 134 and magnetic components of the compressor 100. This improves improve the operation lifetime and effectiveness of the rotor 134, which in turn can improve the performance, efficiency, and operation lifetime of the compressor.

When introducing elements of the present disclosure or the embodiment(s) thereof, the articles “a,” “an,” “the” and “said” are intended to mean that there are one or more of the elements. The terms “comprising,” “including,” “containing” and “having” are intended to be inclusive and mean that there may be additional elements other than the listed elements. The use of terms indicating a particular orientation (e.g., “top,” “bottom,” “side”, etc.) is for convenience of description and does not require any particular orientation of the item described.

As various changes could be made in the above constructions and methods without departing from the scope of the disclosure, it is intended that all matter contained in the above description and shown in the accompanying drawing[s] shall be interpreted as illustrative and not in a limiting sense.

What is claimed is:

1. A compressor comprising:
a compressor housing;
a stator positioned in the compressor housing;
a rotor assembly rotatably supported in the compressor housing, the rotor assembly comprising a permanent magnet rotor positioned within the rotor assembly; and
a magnetic compressor component positioned a distance from the permanent magnet rotor, wherein the distance is sized to reduce heat generated by the permanent magnet rotor.

2. The compressor of claim 1, wherein the magnetic compressor component includes at least one of: a bearing, a bearing housing, a bearing sleeve, a portion of the shaft, or a ferrous component of the compressor.

3. The compressor of claim 1, wherein the permanent magnet rotor has a diameter (D), wherein the distance is at least 0.3*D.

4. The compressor of claim 3, wherein the distance is between 0.33*D to 0.34*D.

5. The compressor of claim 1, wherein the generated heat is reduced between the permanent magnet rotor and the magnetic compressor component.

6. The compressor of claim 5, wherein the distance decreases the heat generated by an additional magnetic compressor component.

7. The compressor of claim 1, wherein the rotor assembly further comprises a shaft.

8. The compressor of claim 7, wherein the shaft encloses an internal void along at least a portion of the distance.

9. The compressor of claim 7, wherein the shaft further comprises a shaft sleeve that receives the permanent magnet rotor.

10. The compressor of claim 9, wherein the shaft further comprises a shaft sleeve cylindrically shaped corresponding to the permanent magnet rotor.

11. The compressor of claim 7, wherein the permanent magnet rotor is secured within the shaft via a press fit connection that extends along at least a portion of the distance.

12. The compressor of claim 1, wherein the reduced heat generation between the permanent magnet rotor and the magnetic compressor component improves operational efficiency of the compressor.

13. A refrigeration system comprising:
an evaporator operable to evaporate a working fluid;
a condenser operable to condense the working fluid; and
a compressor connected to each of the evaporator and the condenser and operable to compress the evaporated working fluid downstream from the evaporator and upstream from the condenser, the compressor comprising:
a compressor housing;
a stator positioned in the compressor housing;
a rotor rotatably supported in the compressor housing, the rotor comprising:
a shaft extending between first and second axial shaft ends, wherein the shaft includes a hollow,
a permanent magnet rotor positioned within the hollow of the shaft; and
a magnetic compressor component positioned a distance from the permanent magnet rotor, wherein the distance is sized to reduce heat generated by the permanent magnet rotor.

14. The refrigeration system of claim 13, wherein the magnetic compressor component includes at least one of: a bearing, a bearing housing, the shaft, or the compressor housing.

15. The refrigeration system of claim 13, wherein a non-magnetic material is positioned along the distance.

16. The refrigeration system of claim 13, wherein the permanent magnet rotor has a diameter (D), wherein the distance is at least 0.3*D.

17. The refrigeration system of claim 16, wherein the distance is between 0.33*D to 0.34*D.

18. The refrigeration system of claim 13, wherein the generated heat is reduced between the permanent magnet rotor and the magnetic compressor component.

19. The refrigeration system of claim 18, wherein the distance is a non-magnetic zone.

20. A method of assembling a compressor, the method comprising:
positioning a rotor in a housing of the compressor, the rotor including a shaft extending between first and second axial shaft ends and a permanent magnet rotor positioned within the shaft, the permanent magnet rotor extending between first and second axial magnet ends;
positioning a stator in the housing;
determining a distance between the first and second axial magnet ends and a magnetic component of the compressor,
wherein the permanent magnet rotor has a diameter, wherein the distance is at least 0.3*D, and
wherein the distance corresponds to reduced heat generation between the permanent magnet rotor and the magnetic component of the compressor; and
positioning the magnetic component within the compressor at the distance from the permanent magnet rotor.
